(19) United States
(12) Patent Application Publication
(10) Pub. No.: US 2008/0181243 A1
(43) Pub. Date: Jul. 31, 2008

(54) ETHERNET FORWARDING IN HIGH PERFORMANCE FABRICS

(75) Inventors: Suresh Vobbilisetty, San Jose, CA (US); Subbarao Arumilli, Santa Clara, CA (US)

Correspondence Address: HENSLEY KIM & HOLZER, LLC, 1660 LINCOLN STREET, SUITE 3000, DENVER, CO, 80264, US

(73) Assignee: BROCADE COMMUNICATIONS SYSTEMS, INC., San Jose, CA (US)

(21) Appl. No.: 11/958,325

(22) Filed: Dec. 17, 2007

Related U.S. Application Data
(60) Provisional application No. 60/870,170, filed on Dec. 15, 2006.
(60) Provisional application No. 60/870,166, filed on Dec. 15, 2006.

(51) Int. Cl. H04L 12/56

(52) U.S. Cl. 370/406

(57) ABSTRACT

As switching device forwards frames through a fabric using high performance routing protocols without requiring changes in receiving and transmitting Ethernet end stations communicating through the fabric. Each frame received by an edge point of a high performance fabric is modified to support a high performance routing protocol while the frame is within the fabric and is restored to its original format when leaving the fabric. Within the fabric, virtual L2 addressing, assigned and maintained by the fabric, is applied to the frame to accommodate the high performance routing.

### CROSS-REFERENCE TO RELATED APPLICATIONS

The present application claims benefit of U.S. Provisional Patent Application No. 60/870,170, filed on Dec. 15, 2006 and entitled “Ethernet Forwarding in High-Performance Fabrics”, which is specifically incorporated by reference herein for all that it discloses and teaches.

The subject matter of the present application is also related to concurrently filed U.S. patent application Ser. No. ______ [Docket No. 112-0206US/233-629-USP], filed Dec. 17, 2007 and entitled “Ethernet over Fibre Channel”, and U.S. Provisional Patent Application No. 60/870,166, filed on Dec. 15, 2006 and entitled “Ethernet over Fibre Channel,” both of which are also specifically incorporated by reference for all that they disclose and teach.

### BACKGROUND

Ethernet networks typically employ a spanning tree protocol (STP) for routing Ethernet frames between end stations through a mesh network of layer-2 (L2) switches. Unfortunately, STP introduces limitations on performance. For example, STP establishes a single active path between any two network nodes (e.g., end stations), precluding performance enhancements available from multi-path routing.

### SUMMARY

Implementations described and claimed herein address the foregoing problems by forwarding Ethernet frames through a fabric using high performance routing protocols without requiring changes in receiving and transmitting Ethernet end stations communicating through the fabric. Each frame received by an edge switch of a high performance fabric is modified to support a high performance routing protocol while the frame is within the fabric and is restored to an end-station-compatible format when leaving the fabric. Within the fabric, virtual L2 addressing, which is assigned and maintained by the fabric, is applied to the frame to accommodate the high performance routing.

Other implementations are also described and recited herein.

### BRIEF DESCRIPTIONS OF THE DRAWINGS

FIG. 1 illustrates an exemplary computing and storage framework including end stations and a high performance fabric.

FIG. 2 illustrates an example configuration for forwarding Ethernet frames through a high performance fabric.

FIG. 3 illustrates example encapsulated Ethernet frames.

FIG. 4 illustrates example operations for forwarding an Ethernet frame through a high performance network.

FIG. 5 illustrates another example configuration for forwarding Ethernet frames through a high performance fabric.

FIG. 6 illustrates example operations for forwarding an Ethernet frame through a high performance network.

### DETAILED DESCRIPTIONS

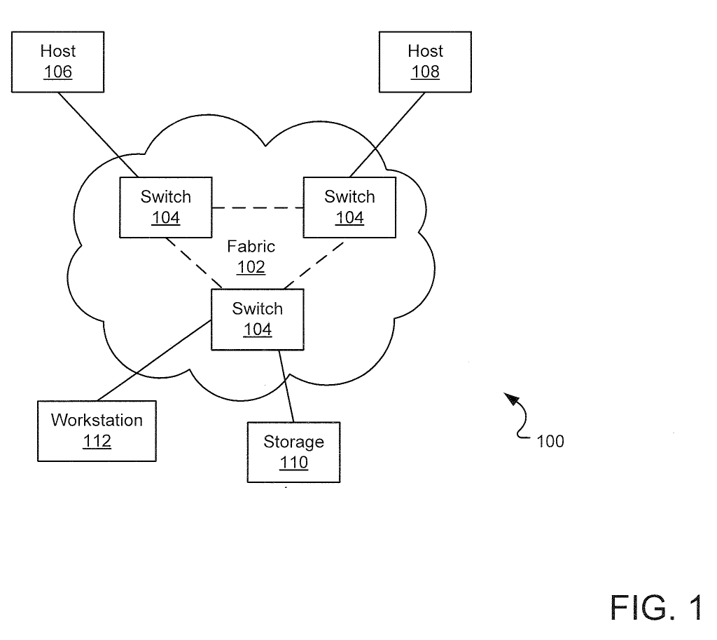

FIG. 1 illustrates an exemplary computing and storage framework 100 including end stations and a high performance fabric 102. The fabric 102 includes interconnected Ethernet switches 104 that provide communications networking for the end stations. The end stations, such as hosts 106 and 108, storage unit 110, and workstation 112, represent physical end points to communications across the fabric 102. Nevertheless, it should be understood that additional or alternative networking equipment may exist inside and/or outside the high performance fabric 102, such as assorted Ethernet routers and switches, Fibre Channel switches, etc. (not shown).

In one implementation, the fabric 102 is an Ethernet network coupled to the end stations to provide communications among the end stations. However, the switches 104 in the fabric 102 are configured to provide high performance forwarding across the Ethernet network. In contrast to a traditional Ethernet network, which employs a single-path STP, the switches 104 in the fabric 102 are configured to support multi-path routing without requiring changes to the end stations.

The switches 104 are termed “edge switches” because they are the ingress and egress points of the high performance fabric 102. Other switches (not shown, but suggested by the dashed lines interconnecting the edge switches 104) within the fabric 102 are termed “intermediate switches” because they do not connect to end stations outside the fabric 102.

The edge switches and intermediate switches are responsible for forwarding Ethernet frames received by an edge switch from a source end station to a destination end station across the fabric 102. For example, as an edge switch, the switch 104 virtualizes and de-virtualizes the addressing of each frame it receives into and transmits out of the fabric 102. In addition, an edge switch 104 and any intermediate switches are also configured to execute a high performance routing protocol, such as a Domain_ID/Port_ID-based routing similar to FSPF, based on the virtual addressing applied by the edge switches.

Each end station has a physical MAC (media access controller) address (or “PMAC address”). The PMAC address is typically assigned to the Ethernet interface device of the end station by the device's vendor (e.g., the PMAC address may be stored in an EPROM on the device), although PMAC addresses may also be assigned in other manners. The end station includes its PMAC address in a source address (SA) field of each Ethernet frame it transmits through the fabric 102. Also, the end station also includes a PMAC address of an intended destination end station in the destination address (DA) field of an Ethernet frame transmitted through the fabric 102.

In the illustration of FIG. 1, the high performance fabric 102 transforms the frames passing through it between end stations. An edge switch 104 in the fabric 102 that receives an Ethernet frame from an Ethernet end-station outside the fabric 102 adds one or more virtual MAC (media access controller) addresses to the frame, such as a virtual source MAC address and a virtual destination MAC address. A virtual MAC address is also referred to herein as a “VMAC address” and represents a virtual end-point address associated with an edge switch port or a physical end station. Accordingly, each VMAC address can correspond with a port of the edge switch coupled to a physical end station, the physical end station itself, or some other virtual end-point. A VMAC address is an IEEE MAC address assigned and locally administered by the high performance fabric 102. One example VMAC has the following form, although other VMAC formats may be employed:

TABLE 1
Example VMAC address format

| 1 bit | 1 bit | 20 bits | 12 bits | 14 bits |
|---|---|---|---|---|
| [47] | [46] | [45:26] | [25:14] | [13:0] |
| U/M | U/L | Reserved | Domain ID | Port ID |

The U/M and U/L fields store type designators of the frame in accordance with standard IEEE definitions. The U/M field indicates whether the VMAC address is a unicast MAC address (0) or a multicast MAC address (1). The U/L field indicates whether the VMAC address is universally administered (0) or locally administered (1). The bits designated as “Reserved” are not specified and may be used for other defined purposes.

The Port_ID field stores the Port_ID of the port of the domain on which the VMAC address resides (e.g., the port of the switch to which the end station is coupled). The Domain_ID field stores the Domain_ID of the switch on which the VMAC address resides. The domain to which a PMAC address is physically connected is referred to as the “home domain” of the VMAC address.

Although not illustrated in Table 1, the VMAC address format may include an 8-bit TTL (time-to-live) field that is specified to store a TTL value governing how long the frame may propagate through the network. The units of the TTL value are seconds, indicating a time-based value. However, because each network device (e.g., a router or switch) that transfers the frame reduces the TTL value by at least one second, the TTL may degenerate to a hop count. If the TTL is decremented to zero or below, the frame is no longer propagated through the network and is therefore discarded. In one implementation, the TTL field is located in bit locations [26:33].

The hierarchy embedded in the VMAC address (e.g., via the Domain_ID and Port_ID) resembles the hierarchy in a Fibre Channel address. Therefore, intermediate switches in the fabric 102 can examine the VMAC address and, using the Domain_ID and Port_ID from the VMAC address, forward frames based on a Domain and Area-based routing protocol, similar to FSPF (Fabric Shortest Path First) used in Fibre Channel. To support such a high performance routing protocol, each intermediate switch in the fabric 102 is assigned a Domain_ID and one or more ports of each intermediate switch in the fabric 102 are assigned a PORT_ID, such as by using a negotiation technique similar to that employed in Fibre Channel switches during Fibre Channel fabric formation. It should be understood that other fabric formation and high performance routing protocols may also be employed. It should also be understood that switches acting as ingress edge points can also classify the incoming frames and perform standard IEEE 802.1D VLAN tagging so as to enable separate FSPF instances for each configured VLAN.

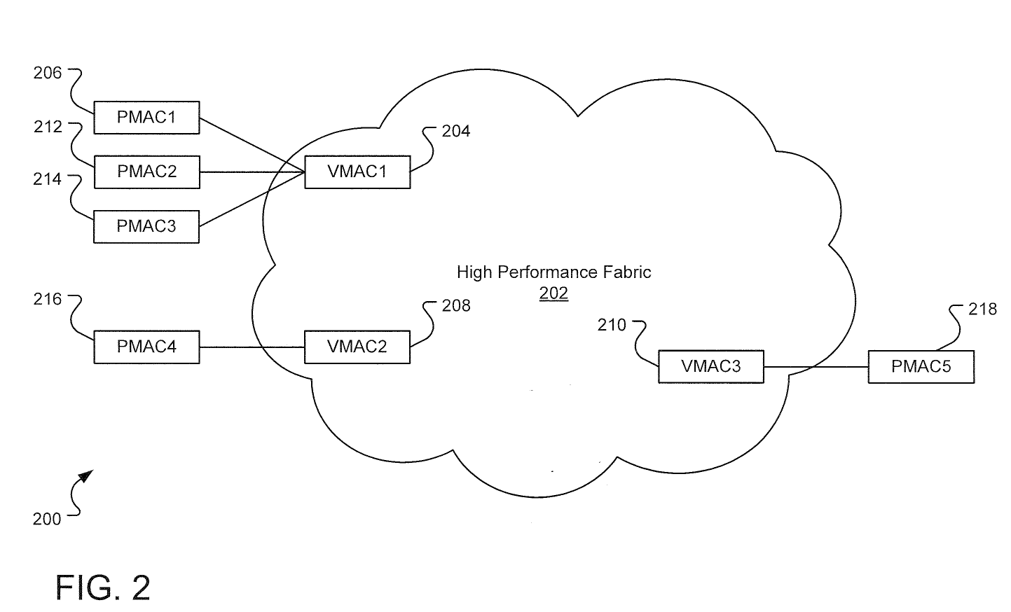

FIG. 2 illustrates an example configuration 200 for forwarding Ethernet frames through a high performance fabric 202. Edge switches 204, 208, and 210 are positioned at the boundary of the fabric 202. The edge switches are coupled through distinct ports to end stations, such as end stations 206, 212, 214, 216, and 218.

In the illustrated implementation, each port of an ingress edge switch connected to an Ethernet end station device is assigned a VMAC address by the fabric 202 when the switch is initialized. This approach fixes a virtual end point to the point where the transmitting Ethernet end station device is connected to the fabric 202 (e.g., the edge switch port connected to the end station). Each VMAC address includes the Domain_ID of the edge switch and the Port_ID of the port to which the VMAC address is assigned. For example, if an edge switch 204 having a Domain_ID of “10” in the fabric 202 is connected to an Ethernet end station device 206 via a port of the edge switch 204 having a Port_ID of “2”, then the VMAC address at the virtual end point may take the form of:

TABLE 2
Example VMAC address with example values

| U/M | U/L | 20 bits | 12 bits | 14 bits |
|---|---|---|---|---|
| [47] | [46] | [45:26] | [25:14] | [13:0] |
| 0 | 1 | TBD | 10 | 2 |

Each VMAC address may also include a TTL field.

In one example, the source end station 218 (which has PMAC5) transmits an Ethernet frame for delivery to the destination end station 206 (which has PMAC1) through the fabric 202. The source end station 218 is coupled to the fabric 202 via a port of the ingress edge switch 210 (which has been assigned VMAC3). The destination end station 206 is coupled to the fabric 202 via a port of egress edge switch 204 (which has been assigned VMAC1).

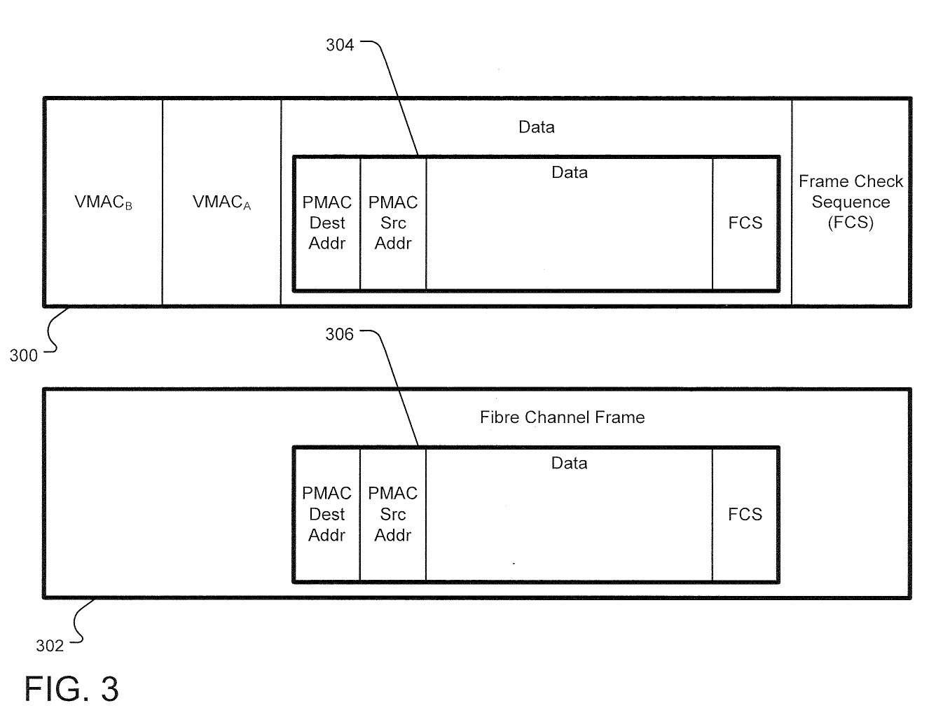

Generally, upon receiving the Ethernet frame from the source end station 218, a frame translation module of the ingress edge switch 210 modifies the L2 addressing of the frame by adding its port's VMAC address (VMAC3) as the source L2 address of the frame and adding the VMAC address of the egress port of the egress edge switch 204 (VMAC1) as the destination L2 address of the frame. In one implementation, an address translation module of the ingress edge switch 210 determines the appropriate ingress and egress VMAC addresses. The frame translation module of the ingress edge switch 210 encapsulates the received Ethernet frame in an Ethernet frame shell in which the destination and source address fields contain the egress and ingress VMAC addresses respectively. Examples of encapsulated frames are described with regard to FIG. 3.

To determine the ingress VMAC address in one implementation, the edge switch 210 maintains a port-to-VMAC table (e.g., generated at initialization time), which maps Port_IDs of ports that receive Ethernet frames for communication through the high performance fabric 202 to the ports' VMAC addresses. The edge switch 210 looks up the source VMAC address for the port in the table and then uses the resulting VMAC address (VMAC3) as the SA of the encapsulated frame to be forwarded through the fabric 202

To determine the egress VMAC address in one implementation, the edge switch 210 maintains a destination PMAC-to-VMAC table, which maps the PMAC addresses of known destination end stations to the VMAC addresses of the egress edge switch ports to which the destination end stations are coupled. If the switch's PMAC-to-VMAC table includes a mapping for the destination station's PMAC address, then the switch uses the corresponding VMAC address (VMAC1) as the DA of the encapsulated frame. After the encapsulation is accomplished, a transmission module of the ingress edge switch 210 then forwards the frame through the fabric 202 (e.g., using a Domain and Area-based routing protocol) to the egress edge switch 204.

When the egress edge switch 204 receives the encapsulated Ethernet frame, it de-encapsulates the forwarded frame to obtain the original Ethernet frame, thereby restoring the original L2 addressing to PMAC5 and PMAC1 (as source and destination addresses, respectively), and transmits the recovered frame to the destination end station 206 through the appropriate port, which is specified in the destination VMAC address.

When the destination end station 206 responds to the original Ethernet frame, the response Ethernet frame is sent to the edge switch 204 with PMAC addresses. The edge switch 204 encapsulates the response frame using VMAC addresses, in the same manner as described with regard to the edge switch 210 and the original Ethernet frame, and forwards the encapsulated response frame into the fabric 202 using the destination VMAC address. The edge switch 210 receives the response frame and de-encapsulates it in the same manner as described with regard to edge switch 204 and forwards the internal frame on to the original source end station 218. Communications through the fabric 202 continue using this forwarding method between the end stations 218 and 206 via each edge switch 210 and 204.

If a switch's PMAC-to-VMAC table does not already include a record for a specific destination PMAC address (PMAC1), the ingress edge switch 210 floods (e.g., multicasts) the encapsulated frame into the fabric with a special multicast VMAC address. The SA of the flooded encapsulated frame is the VMAC address (VMAC3) of the edge switch's port that received the frame.

If the destination end station 206 is coupled to the fabric 202 (as it is in FIG. 2), it receives the flooded frame through the egress edge switch 204, which de-encapsulates the frame to expose the original frame and transmits it to the end station 206 with its PMAC addressing. The destination end station 206 then responds back through the same egress edge switch 204 with a response frame that includes its own PMAC address (PMAC1) as the SA and the original source end station's PMAC (PMAC5) as the DA. The egress edge switch 204 then encapsulates the response frame using its port's VMAC address (VMAC1) as the SA in the Ethernet frame shell and the VMAC address (VMAC5) of the ingress edge switch's port (taken from the switch's PMAC-to-VMAC table) as the DA. The egress edge switch 204 then forwards the response frame through the fabric using this VMAC addressing.

Therefore, when the encapsulated response frame is received by the ingress edge switch 210, the edge switch 210 determines a mapping between the original destination PMAC address (PMAC1) and the VMAC address (VMAC1) of the port on the egress edge switch 204 that is connected to the destination end station 206. This mapping is determined from the VMAC SA of Ethernet frame shell of the response frame and the PMAC SA of the internal Ethernet frame of the response frame. The edge switch 210 records this mapping in its PMAC-to-VMAC table. For future forwarding to the destination end station's PMAC address (PMAC1), the ingress edge switch 210 extracts the corresponding VMAC address (VMAC1) for the egress edge switch's port from its PMAC-to-VMAC table and inserts it into the destination address field of the Ethernet frame shell that encapsulates each frame it is forwarding to the destination end station 206.

In contrast to the forwarding of Ethernet frames through a fabric of Ethernet switches using a high performance routing protocol, Ethernet frames may also be forwarded through a Fibre Channel fabric using an encapsulation technique similar to that described above. As shown in FIG. 3, the original Ethernet frame may be encapsulated in a Fibre Channel frame shell for forwarding through the high performance Fibre Channel fabric. Source and destination Fibre Channel Domain and Port IDs may be assigned as analogous to the source and destination VMAC addresses described with regard to FIG. 2. Furthermore, in the flooding condition, the flooded packet may be configured with a multicast destination ID and a source ID of the ingress switch, wherein the multicast group of the multicast destination ID includes other edge switches coupled to the fabric.

FIG. 3 illustrates example encapsulated Ethernet frames. An original Ethernet frame 304 represents, for example, a frame transmitted from a source Ethernet end station to an ingress edge switch A. The ingress edge switch A encapsulates the original Ethernet frame 304 in an Ethernet frame shell to form the encapsulated Ethernet frame 300. The Ethernet frame shell includes a DA field containing the VMAC_{B} address of the port of the egress edge switch B coupled to the intended destination end station, a SA field containing the VMAC_{A} address of the port of the ingress edge switch A coupled to the source end station, and a frame check sequence (FCS). Upon receipt, the egress edge switch B de-encapsulates the original Ethernet frame 304 from the encapsulated Ethernet frame 300 and forwards it to the destination Ethernet end station through the port that is mapped to the VMAC_{B} address. The original Ethernet frame 304 includes the original source and destination PMAC addresses.

As an alternative implementation, an original Ethernet frame 306 represents, for example, a frame transmitted from a source Ethernet end station to an ingress edge switch A for transmission through a Fibre Channel fabric. The ingress edge switch A encapsulates the original Ethernet frame 306 in a Fibre Channel frame shell to form the encapsulated Fibre Channel frame 300. The Fibre Channel frame shell includes a destination ID field containing the Port_ID of the port of the egress edge switch B coupled to the intended destination end station, a source ID field containing the Port_ID of the port of the ingress edge switch A coupled to the source end station, and a frame check sequence (FCS). Upon receipt, the egress edge switch B de-encapsulates the original Ethernet frame 304 from the encapsulated Fibre Channel frame 300 and forwards it to the destination Ethernet end station through the port designated by the destination Port_ID. The original Ethernet frame 304 includes the original source and destination PMAC addresses. In yet another implementation, the original Ethernet frame could be encapsulated in an Infiniband frame or some other frame compatible with high-performance (e.g., multi-path) routing.

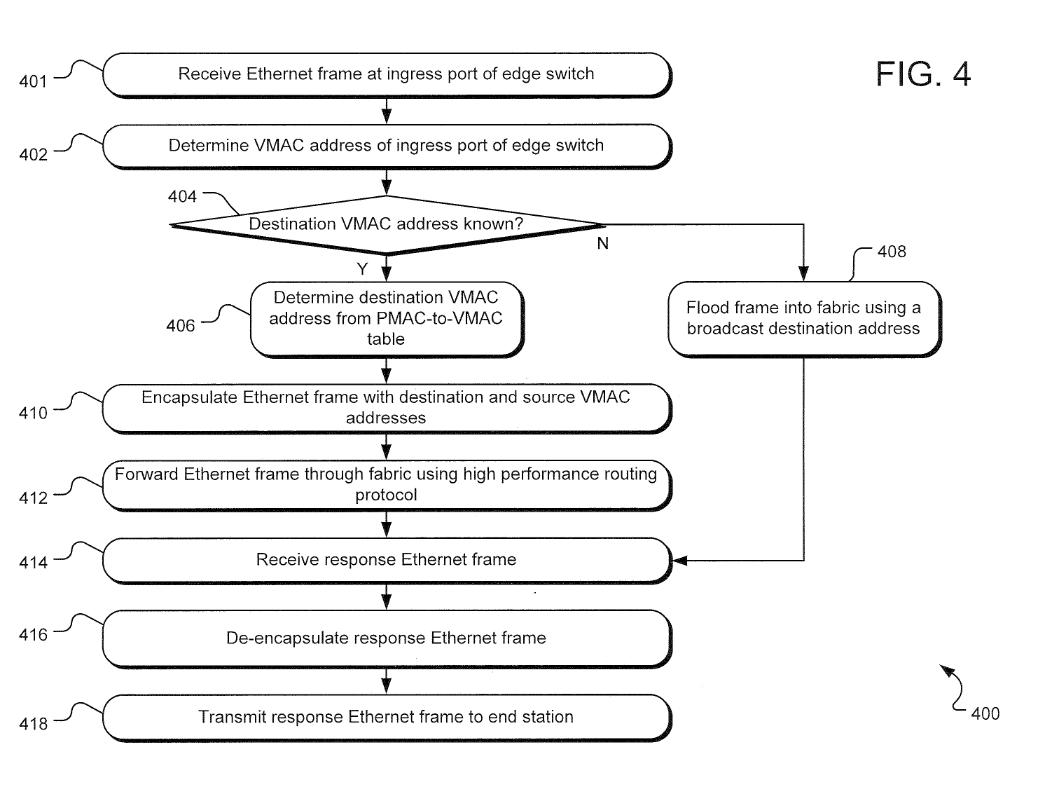

FIG. 4 illustrates example operations 400 for forwarding an Ethernet frame through a high performance fabric. A receiving operation 401 receives an Ethernet frame of an ingress port of an edge switch. A source address operation 402 determines the VMAC address for the ingress port of the edge switch. In one implementation, the edge switch refers to a port-to-VMAC table and looks up the source VMAC address associated with the ingress port.

A decision operation 404 refers to the edge switch's PMAC-to-VMAC table to determine whether a destination VMAC address is known for the destination PMAC address of the received frame. If so, a look up operation 406 determines the destination VMAC address from the table and proceeds to an encapsulation operation 410.

Otherwise, a flooding operation 408 encapsulates the received frame in an Ethernet frame shell, having a multicast VMAC address as its DA and the source VMAC address determined in operation 402 as its SA, and transmits the encapsulated frame into the fabric. In this flooding operation 408, the fabric routes the frame in accordance with its high performance routing protocol. If the destination end station associated with the destination PMAC address is coupled to the fabric, it receives the frame through its egress edge switch, which de-encapsulates the frame and transmits the internal frame to its destination end station based on the destination PMAC address.

When the end station responds back through its edge switch with a PMAC-addressed frame, the edge switch encapsulates the response frame in an Ethernet frame shell having the VMAC address of its port as the SA and the VMAC address associated with the edge switch port coupled to the original source end station as its DA.

A receiving operation 414 receives the encapsulated response frame at the original ingress edge switch. Upon receipt of the response frame, the original ingress edge switch can update its own destination PMAC-to-VMAC table using the source VMAC address of the encapsulated response frame and the source PMAC address of the response Ethernet frame within the encapsulation, if necessary. A de-encapsulation operation 416 de-encapsulates the response frame. A transmission operation 418 transmits the exposed response frame through the appropriate port to the original end station.

Returning to the decision operation 404, in the case where the destination VMAC address is already recorded in the PMAC-to-VMAC table, an encapsulation operation 410 encapsulates the original Ethernet frame in an Ethernet frame shell that uses the destination VMAC address as its DA and the VMAC address of the receiving port on the ingress edge switch as its SA. A forwarding operation 412 forwards the encapsulated Ethernet frame through the fabric using a high performance routing protocol (e.g., FSPF) to the egress edge switch associated with the destination VMAC address.

Upon receiving the encapsulated frame, the egress edge switch can update its own PMAC-to-VMAC table using the source VMAC address of the encapsulated frame and the source PMAC address of the original Ethernet frame within the encapsulation, if necessary. The egress edge switch also de-encapsulates the frame and transmits the de-encapsulated frame to the destination end station based on the destination PMAC address of the internal Ethernet frame.

When the end station responds to the frame, it sends a response frame having source and destination PMAC addresses to its edge switch. The edge switch operates in a similar manner to the original ingress station by performing operations such as operation 401, 402, 404, 406, 410 and 412.

The receiving operation 414 receives the response frame at the original ingress edge switch. The de-encapsulation operation 416 de-encapsulates the response frame. The transmission operation 418 transmits the exposed response frame through the appropriate port to the original end station.

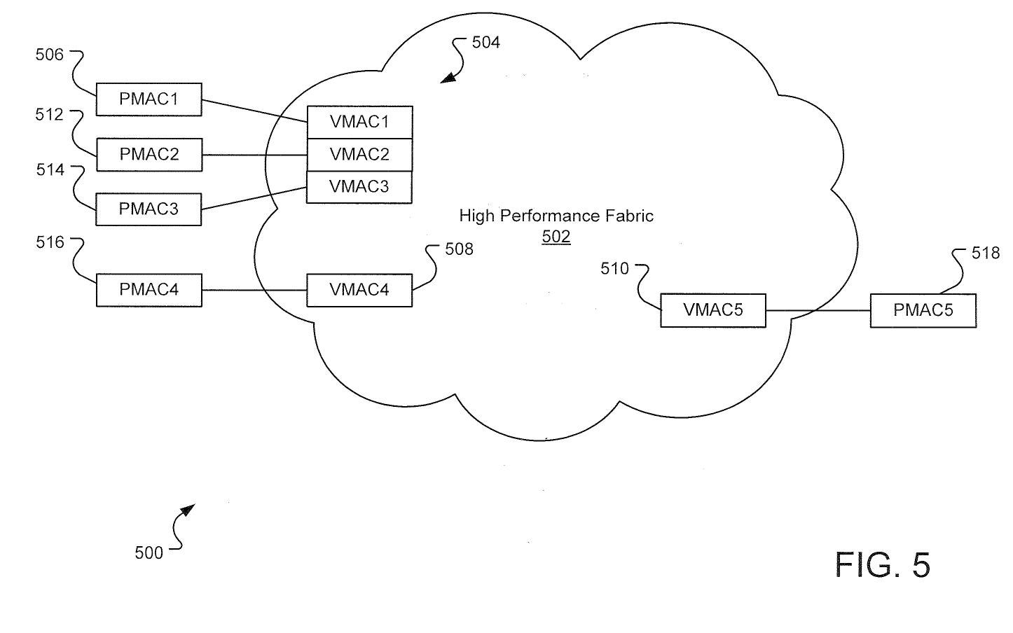

FIG. 5 illustrates another example configuration 500 for forwarding Ethernet frames through a high performance fabric 502. Edge switches 504, 508, and 510 are positioned at the boundary of the fabric 502. The edge switches are coupled through distinct ports to end stations, such as end stations 506, 512, 514, 516, and 518.

In the illustrated implementation, each end station communicating through the fabric 502 is assigned a VMAC address. A result of such an assignment is a PMAC-to-VMAC address mapping for each end station. This approach fixes a virtual end point to each Ethernet end station device connected to the fabric 502. In one implementation, each VMAC address includes the Domain_ID of the boundary switch and the Port_ID of the port to which the end station is coupled. Each VMAC address may also include a TTL field.

In one example, the source end station 518 (which has PMAC5) transmits an Ethernet frame for delivery to the destination end station 506 (which has PMAC1) through the fabric 502. The source end station 518 is coupled to the fabric 502 via a port of the ingress edge switch 510. The destination end station 506 is coupled to the fabric 502 via a port of egress edge switch 504.

In one implementation, the fabric maintains a registry (e.g., a FC Name Server) that tracks the mappings between learned end station PMAC addresses and generated end station VMAC addresses. The registry represents a shared database associated with the switches in the network. After registration, the mapping information can be reported out to or otherwise accessed by switches (including edge switches) in the fabric so that the switches can update and maintain their internal tables of PMAC-to-VMAC mappings.

It should be understood, however, that under some circumstances, a lag exists between registration of a new end station (i.e., a new PMAC address) in the fabric and the availability of the mapping to an edge switch. This lag may result in the edge switch having no record of the appropriate destination PMAC-to-VMAC mapping in its table to apply to a newly received frame. As described below, if the edge switch has no appropriate PMAC-to-VMAC mapping, the edge switch may nevertheless flood the new frame through the fabric using the original destination PMAC address. Thereafter, when the edge switch receives a subsequent frame destined to the same PMAC address, the frame may be received after the PMAC-to-VMAC mapping table has been updated, such that the frame may be transmitted via high performance routing according to the appropriate uni-cast VMAC address taken from the updated PMAC-to-VMAC table.

Generally, upon receiving the Ethernet frame from the source end station 518, an address translation module of the ingress edge switch 510 attempts to replace the destination PMAC address (PMAC1) of the frame with a destination VMAC address (VMAC1) that is mapped to the destination PMAC address. As previously described, to determine the appropriate destination VMAC address in one implementation, an address translation module of the edge switch 510 maintains a PMAC-to-VMAC table, which maps the PMAC in order to addresses of known end stations to their VMAC addresses. The PMAC-to-VMAC mappings are maintained in the fabric registry as well as in the edge switch's internal mapping table. After the replacement of the destination PMAC address with the destination VMAC address (VMAC1) is accomplished, a transmission module of the ingress edge switch 510 then forwards the frame through the fabric 502 using a high performance routing protocol (e.g., a Domain and Area-based routing protocol) to the egress edge switch 504. When the egress edge switch 504 receives the frame with the destination VMAC address, it replaces the destination VMAC address (VMAC1) with the destination PMAC address (PMAC1) from its own PMAC-to-VMAC table and transmits the frame to the destination end station 506 through the appropriate port.

When the destination end station 506 responds, the response frame is sent to its edge switch 504 with the destination PMAC address (PMAC5) of the original end station 518 and the source PMAC address (PMAC1) of the responding end station 506. The edge switch 504 replaces the destination end station's PMAC address (PMAC5) with the destination end station's VMAC address (VMAC5) from its PMAC-to-VMAC table, in the same manner as described with regard to the edge switch 510 and the original Ethernet frame. The modified response frame is then forwarded through the fabric using a high performance routing protocol based on the destination VMAC address (VMAC5).

The edge switch 510 receives the forwarded response frame, replaces the destination VMAC address (VMAC5) with the destination PMAC address (PMAC5) of the destination end station 518 from its PMAC-to-VMAC table, and transmits the frame to the destination end station 518 through the appropriate port. Communications through the fabric 502 between the end stations 518 and 506 continue using this forwarding method via each edge switch 510 and 504.

In the previously described situation of the ingress edge switch's mapping table not already containing a record for a specific destination PMAC address (e.g., because of the previously mentioned lag through the registration process), the ingress edge switch 510 attempts communication to the destination end station 506 via another mechanism. In one implementation, the ingress edge switch 510 floods the received frame (i.e., with PMAC addressing) on a loop free tree within the fabric with the ingress edge switch 510 as the root of the tree. If the destination end station 506 is coupled to the fabric 502 (as it is in FIG. 5), it receives the flooded frame through the egress edge switch 504 (based on the original destination PMAC address). Communication via PMAC addressing may occur whenever a PMAC-to-VMAC mapping of destination addresses is unavailable.

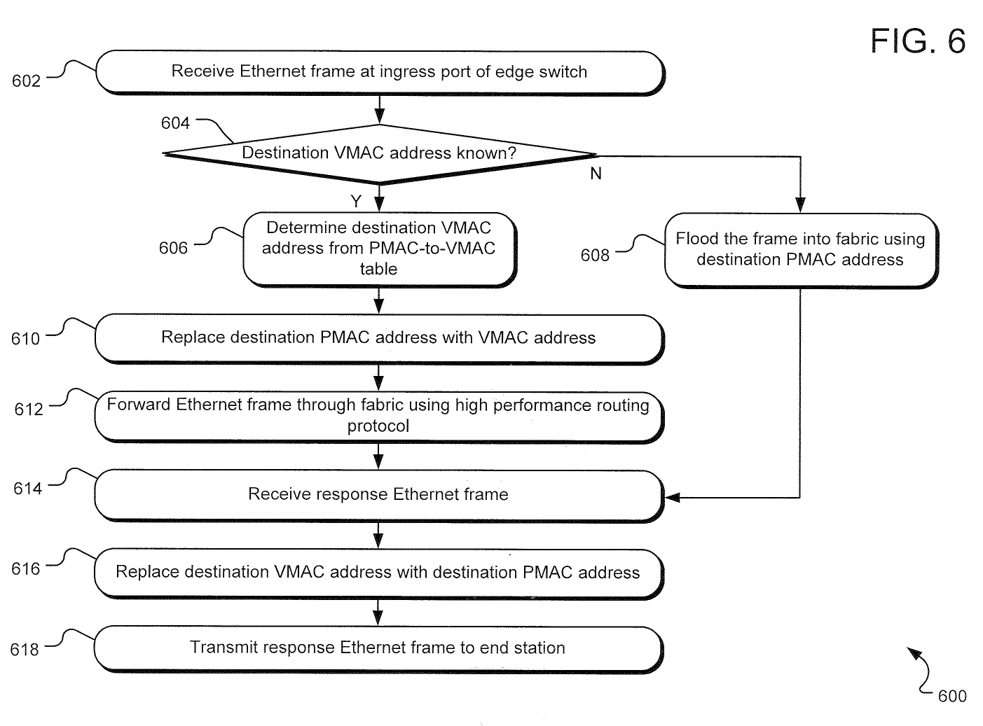

FIG. 6 illustrates example operations 600 for forwarding an Ethernet frame through a high performance fabric. A receiving operation 602 receives an Ethernet frame at an ingress port of an edge switch. A decision operation 604 refers to its PMAC-to-VMAC table to determine whether a destination VMAC address is known for the destination PMAC address of the received frame. If so, a look up operation 606 determines the destination VMAC address from the table and proceeds to a replacement operation 610.

Otherwise, a flooding operation 608 forwards the received frame by flooding it into the fabric based on the frame's PMAC addressing. In this flooding operation 608, the fabric routes the frame in accordance with its native routing protocol (e.g., STP for Ethernet, FSPF for Fibre Channel, etc.). If the destination end station associated with the destination PMAC address is coupled to the fabric, it receives the frame through an egress edge switch. When the end station responds back through its edge switch, the edge switch replaces the destination PMAC address in the frame with the destination VMAC address of the original end station, based on its own destination PMAC-to-VMAC table. Note: If the responding edge switch does not have the appropriate destination PMAC-to-VMAC mapping in its table, it forwards the response using PMAC addressing.

A receiving operation 614 receives the response frame at the original ingress edge switch. Assuming the response frame includes a destination VMAC address, a replacement operation 616 replaces the destination VMAC address with the appropriate destination PMAC address extracted from the edge switch's PMAC-to-VMAC mapping table. A transmission operation 618 transmits the response frame through the identified port to the original end station.

In the case where the destination VMAC address is already recorded in the PMAC-to-VMAC table (as decided in decision operation 604) and the destination VMAC address is determined (as determined in determination operation 606), a replacement operation 610 replaces the destination PMAC address of the original Ethernet frame with the destination VMAC address of the destination end station. A forwarding operation 612 forwards the modified Ethernet frame through the fabric using a high performance routing protocol (e.g., FSPF) to the egress edge switch associated with the destination VMAC address.

Upon receiving the modified frame, the egress edge switch uses its own PMAC-to-VMAC table to look up the PMAC address for the destination end station and replaces the destination VMAC address of the frame with the PMAC address of the destination end station. The egress edge switch also transmits the Ethernet frame to the destination end station via an appropriate port based on the destination PMAC address. When the end station responds to the frame, it sends to its edge switch a response frame having its source PMAC address and a destination PMAC address. The edge switch replaces the destination PMAC address with the appropriate destination VMAC address from its PMAC-to-VMAC table and forwards the response frame through the fabric using a high performance routing protocol to the original ingress edge switch.

The receiving operation 614 receives the response frame at the original ingress edge switch. Assuming the response frame includes a destination VMAC address, a replacement operation 616 replaces the destination VMAC address with the appropriate destination PMAC address extracted from the edge switch's PMAC-to-VMAC mapping table. A transmission operation 618 transmits the response frame through the identified port to the original end station.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method of forwarding an Ethernet frame through a fabric that supports multi-path routing, wherein the Ethernet frame has addressing that includes a physical L2 source address of a source end station and a physical L2 destination address of a destination end station, the method comprising:
determining a virtual L2 destination address for the Ethernet frame, wherein the virtual L2 destination address includes information used for multi-path routing the frame to the destination end station;
modifying the addressing of the Ethernet frame to include the determined virtual L2 destination address;
forwarding the modified Ethernet frame through the fabric to the destination end station using a multi-path routing protocol based on the addressing of the modified Ethernet frame.

2. The method of claim 1 wherein the virtual L2 destination address identifies a domain identifier of an edge switch receiving the Ethernet frame from the source end station.

3. The method of claim 1 wherein the virtual L2 destination address identifies a port identifier of a port of an edge switch receiving the Ethernet frame from the source end station.

4. The method of claim 1 wherein the virtual L2 destination address identifies a time-to-live value associated with the modified Ethernet frame.

5. The method of claim 1 wherein the determining operation comprises:
determining the virtual L2 destination address based the physical L2 destination address of the destination end station.

6. The method of claim 1 further comprising:
determining a virtual L2 source address based on a port of an ingress edge switch through which the Ethernet frame is received from the source end station.

7. The method of claim 6 wherein the modifying operation comprises:
encapsulating the Ethernet frame in a frame shell having the virtual L2 destination address as a destination address of the encapsulated frame and the virtual L2 source address as a source address of the encapsulated frame.

8. The method of claim 1 wherein the modifying operation comprises:
replacing the physical L2 destination address with the virtual L2 destination address in the Ethernet frame.

9. A switching device for forwarding an Ethernet frame through a fabric that supports multi-path routing, wherein the Ethernet frame has addressing that includes a physical L2 source address of a source end station and a physical L2 destination address of a destination end station, the switching device comprising:
an address translation module that determines determining a virtual L2 destination address for the Ethernet frame, wherein the virtual L2 destination address includes information used for multi-path routing the Ethernet frame to the destination end station;
a frame translation module that modifies the addressing of the Ethernet frame to include the determined virtual L2 destination address;
a transmission module that forwards the modified Ethernet frame through the fabric to the destination end station using a multi-path routing protocol based on the addressing of the modified Ethernet frame.

10. The switching device of claim 9 wherein the virtual L2 destination address identifies a domain identifier of an edge switch receiving the Ethernet frame from the source end station.

11. The switching device of claim 9 wherein the virtual L2 destination address identifies a port identifier of a port of an edge switch receiving the Ethernet frame from the source end station.

12. The switching device of claim 9 wherein the virtual L2 destination address identifies a time-to-live value associated with the modified Ethernet frame.

13. The switching device of claim 9 wherein the address translation module determines the virtual L2 destination address based the physical L2 destination address of the destination end station.

14. The switching device of claim 9 wherein the address translation module further determines a virtual L2 source address based on a port of an ingress edge switch through which the Ethernet frame is received from the source end station.

15. The switching device of claim 14 wherein the frame translation module encapsulates the Ethernet frame in a frame shell having the virtual L2 destination address as a destination address of the encapsulated Ethernet frame and the virtual L2 source address as a source address of the encapsulated Ethernet frame.

16. The switching device of claim 9 wherein the frame translation module replaces the physical L2 destination address with the virtual L2 destination address in the Ethernet frame.

17. A method of forwarding an Ethernet frame through a fabric that supports multi-path routing, wherein the Ethernet frame has addressing that includes a physical L2 source address of a source end station and a physical L2 destination address of a destination end station, the method comprising:
determining a virtual L2 destination address for the Ethernet frame, wherein the virtual L2 destination address includes information used for multi-path routing the frame to the destination end station;
modifying the addressing of the Ethernet frame to include the determined virtual L2 destination address, the determined virtual L2 destination address including a domain identifier of an edge switch receiving the Ethernet frame from the source end station and a port identifier of a port of an edge switch receiving the Ethernet frame from the source end station;
forwarding the modified Ethernet frame through the fabric to the destination end station using a multi-path routing protocol based on the addressing of the modified Ethernet frame.

18. The method of claim 17 further comprising:
determining a virtual L2 source address based on a port of an ingress edge switch through which the Ethernet frame is received from the source end station.

19. The method of claim 18 wherein the modifying operation comprises:
encapsulating the Ethernet frame in a frame shell having the virtual L2 destination address as a destination address of the encapsulated frame and the virtual L2 source address as a source address of the encapsulated frame.

20. The method of claim 17 wherein the modifying operation comprises:
replacing the physical L2 destination address with the virtual L2 destination address in the Ethernet frame.
